(19) United States
(12) Patent Application Publication
(10) Pub. No.: US 2014/0066115 A1
(43) Pub. Date: Mar. 6, 2014

(54) Distributed Antenna System Signal Measurement

(71) Applicant: Alan David Sanders, Atlanta, GA (US)

(72) Inventor: Alan David Sanders, Atlanta, GA (US)

(21) Appl. No.: 13/855,695

(22) Filed: Apr. 2, 2013

Related U.S. Application Data
(60) Provisional application No. 61/619,089, filed on Apr. 2, 2012.

(51) Int. Cl. H04B 1/40

(52) U.S. Cl. CPC H04B 1/40
USPC 455/507

(57) ABSTRACT

Disclosed is a method for discriminating among transmitted signals broadcast in a distributed antenna system comprising: verifying that the base transceiver station is operating; determining the number of remote radio units in communication with a head end unit; imposing a plurality of different time delays for a corresponding number of binary data stream transmissions from the head end unit to a pre-determined number of remote radio units; and discriminating among the binary data stream transmissions using an evaluation receiver.

### CROSS REFERENCE TO RELATED APPLICATION

The present Application is related to Provisional Patent Application entitled “Distributed antenna system signal measurement,” filed Apr. 2, 2012 and assigned filing No. 61/619,089, incorporated herein by reference in its entirety.

### FIELD OF THE INVENTION

The present invention relates to a system and method for distinguishing among signals transmitted from a common base transceiver station in a distributed antenna system.

### BACKGROUND OF THE INVENTION

It has been known in the art for some years that a Distributed Antenna System (DAS) can be deployed to provide better coverage or capacity for wireless services in buildings and arenas. FIG. 1 is a diagrammatical illustration of an operational Distributed Antenna System 10 topology comprising a Base Transceiver Station (BTS) 12, a head end unit 14, and a plurality of remote radio units 22-28. A communications link 16 is provided between the Base Transceiver Station 12 and the head end 14. Accordingly, the Base Transceiver Station 12 may communicate with a public land mobile network via the head end 14. Each remote radio unit 22-28 includes a corresponding set of broadcasting antennas 32-38. The broadcasting antennas 32-38 provide broadcast signals over respective antenna coverage zones 52-58.

In the configuration shown, fiber optic links 42-48 may be used to provide communication channels between the Base Transceiver Station 12 and the remote radio units 22-28. A signal may be broadcast from the Base Transceiver Station 12 from all antennas 32-38 via the respective remote radio units 22-28. The head end unit 14 makes identical copies of signals and sends them to the remote radio units 22-28 through the fiber optic links 42-48. Signals from the Base Transceiver Station 12 thus provide for communication in a defined broadcast zone 20. The remote radio units 22-28 convert the signal to Radio Frequency (RF) and send the signal through coaxial to one or more of the antennas 32-38.

To a user mobile communication device (not shown), signals received from each of the remote radio units 22-28 on the same Base Transceiver Station 12 appear to be the same signal. Thus, instead of employing a single antenna disposed at the Base Transceiver Station 12 and radiating at a high power level, the DAS 10 comprises a plurality of low-power and low-profile antennas deployed over a physical region to provide substantially the same communication coverage to the broadcast zone 20.

However, in standard operation, a field-deployed communication measurement device 18, for example, cannot identify an individual source antenna 32-38 or an individual remote radio unit 22-28 as the source of a particular measured signal. Traditionally, the testing of potential wireless locations, either outside locations, inside locations, large coverage areas or small coverage areas, is done with non-modulated signals, called CW signals. Distinguishing and identifying the source of an individual signal is not possible because essentially the same signal is being simultaneously broadcast from all of the remote radio units 22-28 and corresponding antennas 32-38 in the broadcast zone 20 serviced by the BST 12.

As can be appreciated by one skilled in the relevant art, the broadcast signals received from the broadcasting antenna sets 32-38 are substantially identical, with some signal variations resulting from differences in cable lengths, different antenna distances, and signal reflections from solid objects in the broadcast zone 20. Accordingly, radio signal level coverage measurements are typically performed on the broadcast signals for the Base Transceiver Station 12. Because of this, the individual signal components emanating from each of the Remote Radio Unit are usually not measured.

The time difference between different antennas 32-38, for example, will not usually be significant enough to distinguish among the broadcast signals, because the differences in cable lengths and differences in propagation distances are usually not sufficient to provide for measurable signal variations. This means that communication test equipment, like test phones or test scanners, cannot distinguish signals emanating from the plurality of remote radio unit 22-28 connected to the same Base Transceiver Station 12. In addition, there may be a “Near-Far” problem wherein the sensitivity of a particular receiver is largely dependent on the maximum signal being received at any moment. When a test receiver is very close to a broadcasting CW transmitter, weak signals, will be undetectable.

One conventional method of measuring the signals from each remote radio unit 22-28 commonly used by engineers or technicians is to connect one of a transmitter 62-68 to a respective one of the radio units 22-28, as shown in FIG. 2, where each of the transmitter 62-68 broadcasts using unique parameters. Thus, each of the signals from the corresponding transmitters 64-68 in a Test Mode Distributed Antenna System 60 can be distinguished through the use of, for example, different broadcast frequencies, different broadcast codes, or some other method for producing different broadcast signals, in conjunction with the communication measurement device 18. However, it is difficult for one transmitter to be used on multiple RF frequencies because when the receiver and transmitter are using different RF frequencies (at a given moment) the receiver will not be able to differentiate between a weak or undetectable signal and when the transmitter is on a different frequency.

There are a few, related, disadvantages to this method of testing the coverage and radiation coming from dispersed remote radio units. Firstly, it is often very difficult to attach a transmitter to some remote radio unit because the unit may be located in a place with no access or with difficult physical access. Relatedly, attaching transmitters directly to remote radio units, as in the test mode Distributed Antenna System 60, costs more money, in labor and equipment, and takes longer than may be acceptable to a user.

There is also known to be an alternative testing methodology that makes use of short, coded, bursts that have high processing gain and low autocorrelation and cross correlation with other codes. However, as the number of such unique codes is increased in the testing procedure, the processing at the receiver increases accordingly. And, as can be appreciated by one skilled in the relevant art, the more signal processing that is required at the receiver, the slower is the resulting data collection rate. What is needed is a method of testing the coverage and radiation coming from dispersed remote radio units that does not suffer from the shortcomings of the present state of the art.

### BRIEF SUMMARY OF THE INVENTION

The present invention addresses the disadvantages discussed above by providing for distinctive delayed or modulated signals from the remote radio units in the distributed antenna system. This methodology is enabled by an advantageous feature available in certain types of head-end units or host units. A head-end unit having a programming access allows a technician to digitally program a signal modulation, or a selected broadcast delay, for the signal emanating for an individual remote radio unit. That is, the disclosed method functions to configure and to send delayed or modulated versions of the conventional output signal for each remote radio unit broadcasting in a coverage zone.

In an aspect of the present invention, a method for discriminating among transmitted signals broadcast via a plurality of remote radio units in communication with a distributed antenna system base transceiver station comprises: verifying that the base transceiver station is providing a base transceiver station signal to a head end unit in the distributed antenna system; determining the number of remote radio units in communication with the head end unit; imposing, for a pre-determined number of remote radio units in communication with the head end unit, a plurality of different time delays for a corresponding number of binary data stream transmissions from the head end unit to the respective pre-determined number of remote radio units; and discriminating, using an evaluation receiver, among the binary data stream transmissions so as to correlate a particular binary data stream received at the evaluation receiver with the remote radio unit transmitting the particular binary data stream.

In another aspect of the present invention, a method of discriminating among transmitted signals broadcast via a plurality of remote radio units in communication with a distributed antenna system base transceiver station comprises: verifying that the base transceiver station is providing a base transceiver station signal to a head end unit in the distributed antenna system; determining the number of remote radio units in communication with the head end unit; imposing, for a pre-determined number of remote radio units in communication with the head end unit, a plurality of coded burst signals for a corresponding number of binary data stream transmissions from the head end unit to the respective pre-determined number of remote radio units; and discriminating, using an evaluation receiver, among the binary data stream transmissions so as to correlate a particular coded burst signal in a binary data stream received at the evaluation receiver with the remote radio unit transmitting the particular coded burst signal.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a distributed antenna system, in accordance with the prior art;

FIG. 2 is a diagrammatical illustration of a distributed antenna system with transmitter units, in accordance with the prior art;

FIG. 3 is a diagrammatical illustration of a distributed antenna test system, in accordance with the present invention, showing the modification of binary data streams used to determine radio transmission parameters;

FIG. 4 is a flow diagram illustrating a method of operation of the distributed antenna system of FIG. 3 using various signal delays for discrimination at an evaluation receiver;

FIG. 5 is a graph showing a broadcast signal having equal signal delays imposed on some of the remote radio units of the distributed antenna system of FIG. 3;

FIG. 6 is a graph showing a broadcast signal having different signal delays imposed on some of the remote radio units of the distributed antenna system of FIG. 3;

FIG. 7 is a graph showing a broadcast signal missing a signal contribution from a remote radio unit;

FIG. 8 is a graph showing a broadcast signal missing two signal contributions from two remote radio units;

FIG. 9 is a diagram illustrating two different constellation diagrams representing Quadrature Phase Shift Keying;

FIG. 10 is a diagram illustrating a group code produced by summing six QSPK codes, in accordance with the prior art;

FIG. 11 is a diagram illustrating a phase states of phase-shift modulation of Base Codes;

FIG. 12 is a diagram illustrating a summation of phase-shifted Quadrature Phase Shift Keying Codes;

FIG. 13 is a flow diagram illustrating a method of operation of the distributed antenna system of FIG. 3 using coded signal bursts;

FIG. 14 is a flow diagram illustrating a method of operation of the distributed antenna system of FIG. 3 using variable phase coded signal bursts;

FIG. 15 is a waveform illustrating signal detection with the evaluation receiver of FIG. 3 set at a low gain; and

FIG. 16 is a waveform illustrating signal detection with the evaluation receiver of FIG. 3 set at a high gain.

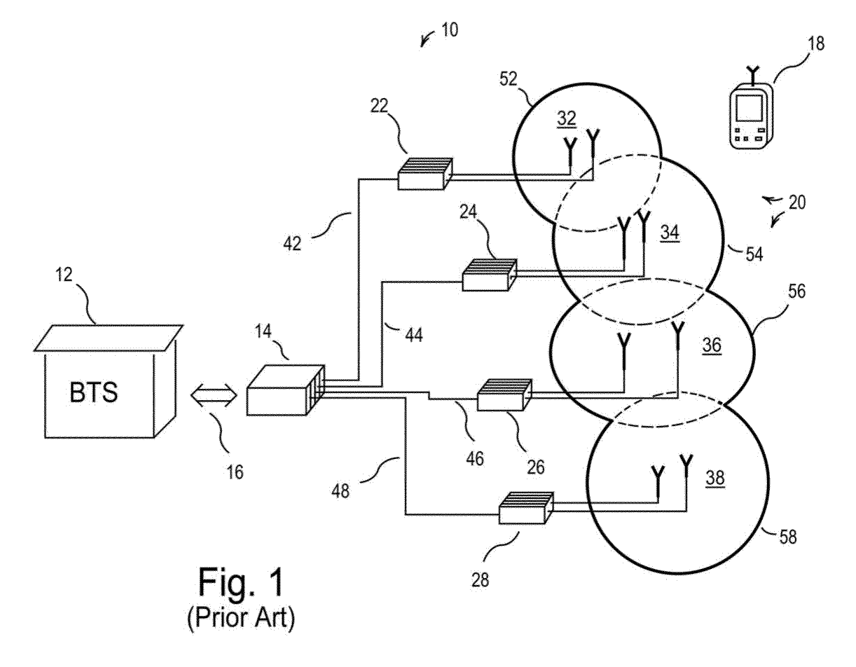

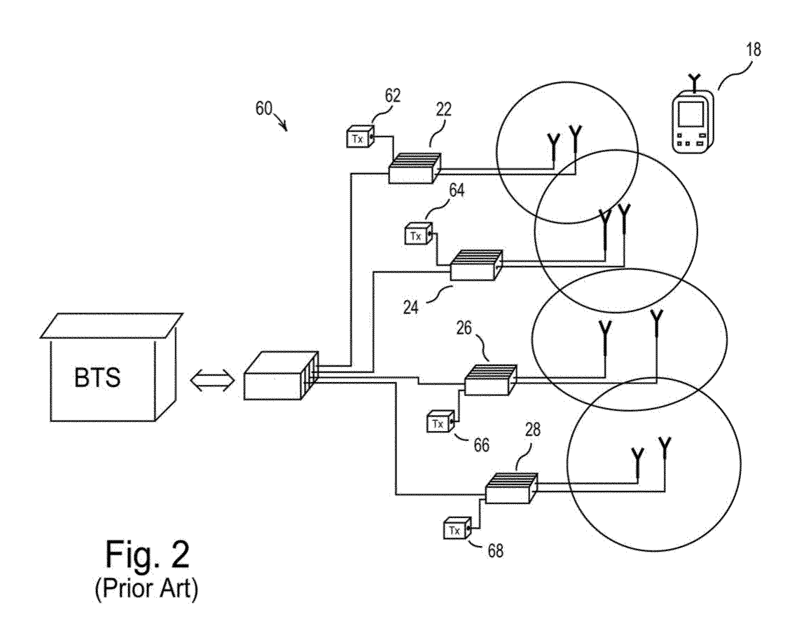

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

The present invention provides the ability to distinguish and measure signals from different remote radio units connected to the same base transceiver station, such as in a distributed antenna system. The disclosed method utilizes a receiver that operates to accurately determine relative times of arrival of signal portions received from the plurality of remote radio units in the same coverage zone. The receiver may perform the determination function by, for example, analysis of signal coding, or by processing gain inherent in the broadcast signal, as can be appreciated by one skilled in the relevant art.

The receiver may alternatively perform the determination function by, for example, analyzing, distinguishing, and measuring signals from the plurality of remote radio units in the same coverage zone by means of using uncorrelated base codes present in the transmission signals. The remote radio unit locations may also be analyzed for various transmission technologies such as, for example, Wi-Fi Standards (e.g., IEEE 802.11), Global System for Mobile (GSM), Wideband Code Division Multiple Access (WCDMA), and Long Term Evolution (LTE). The disclosed method includes modification of transmitted signals and modification of signal reception.

The modification of transmitted signals comprises the generation of encoded signals for subsequent decoding at the receiver. This process enables an evaluation receiver to: (i) individually measure and evaluate signals received from two or more radio units, (ii) discriminate between the received signals, and (iii) determine the source of an individual signal. In the disclosed method, one or more group codes are each built up from a relatively small number of base codes. Accordingly, at the receiver end, correlation calculations need to be made only on the relatively small number of base codes. As described in greater detail below, the methods of creating group signal codes may be used in conjunction with one another.

It should be understood that the disclosed system may be used to identify transmission signals within a structure or building, as well as in an open geographic area. As understood in the relevant art, a structure-deployed distributed antenna system comprises head-end equipment which receives signals from a base station, and converts the RF output signals to digital pulse signals. The digital pulse signals may then be distributed via fiber cabling to a network of remote radio units and antenna access points that are located throughout the structure or building. These antennas receive and broadcast the digitized RF signals to provide wireless coverage of greater reliability than may be possible with a single transmission antenna.

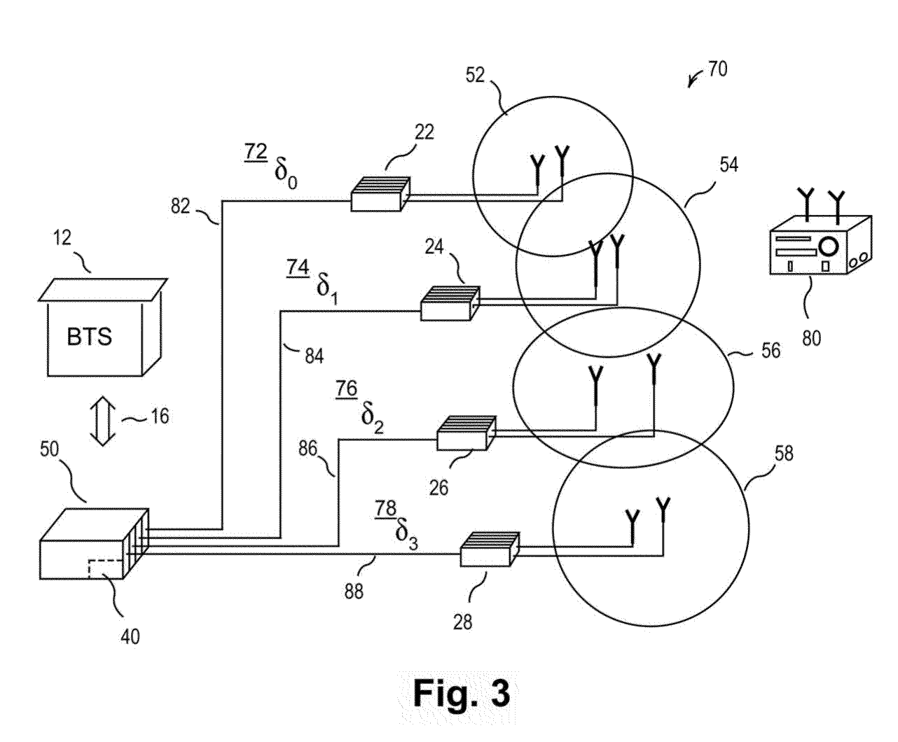

There is shown in FIG. 3 a distributed antenna test system 70, in accordance with the present invention. The Base Transceiver Station 12 is in communication with a head end unit 50 via the communications link 16. The head end unit 50 functions to transmit signals to the remote radio units 22-28 via respective fiber optic links 82-88. In accordance with the present invention, the head end unit 50 includes a programming access feature, such as a binary data stream modulator 40. The data stream modulator 40 can be used by a technician to modify signals incoming to the binary data stream modulator 40 from the common Base Transceiver Station 12, such that the resulting signals on the fiber optic links 82-88 are distinguishable from one another.

An evaluation receiver 80 may be deployed in the field to determine characteristics and operating parameters for the plurality of signals transmitted from the remote radio units 22-28. Because the signals transmitted from the remote radio units 22-28 are distinguishable by virtue of the modification performed by the binary data stream modulator 40, a technician using the evaluation receiver 80 can relate a received signal to the originating remote radio unit. The binary data stream modulator 40 may function, for example, (i) to configure individual time delays for the binary data stream signals transmitting along fiber optic links 82, 84, 86, 88, and/or (ii) to digitally modify the binary data stream signals with a series of coded bursts, as described below.

Thus, by identifying the unique time delay or coded bursts present in a particular binary stream signal received at the evaluation receiver 80, the technician can identify the particular remote radio unit transmitting the particular received signal. In this way, the technician can utilize the evaluation receiver to further measure the signal parameters of the particular binary stream signal, and determine the operational state of the respective remote radio unit, as described in greater detail below.

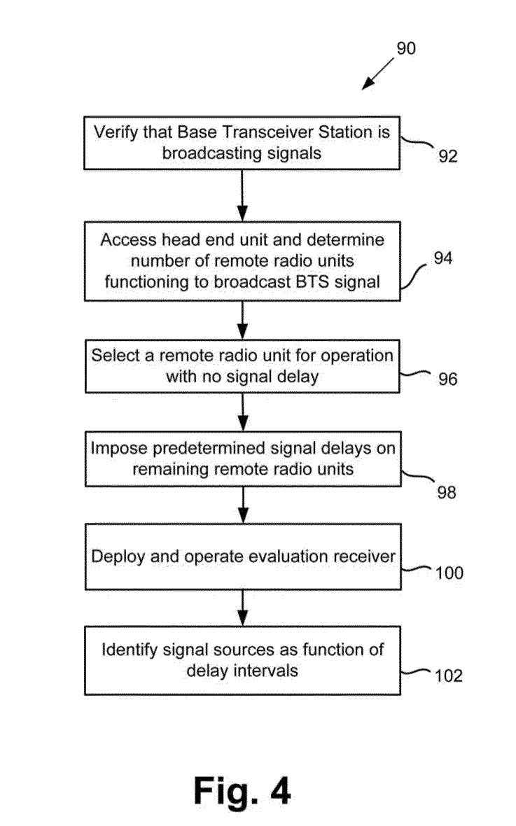

Operation of the distributed antenna test system 70, where a technician is using signal delays for discrimination, for example, may be described with additional reference to a flow diagram 90 in FIG. 4. At step 92, a verification procedure is conducted to verify that the Base Transceiver Station 12 is operating and broadcasting signals before the technician is deployed to the field. The technician may then access the head end unit 50, at step 92, to determine the number of remote radio units that are functioning to broadcast the signal being generated by the Base Transceiver Station 12.

In the example provided, a total of four remote radio units are shown, but it should be understood that the number of remote radio units can be essentially any number that are in communication with a Base Receiver Station of interest. A specified remote radio unit, may be selected for broadcast with no signal time delay, at step 96. In the example provided, there may be a zero delay 72 (i.e., no time delay), denoted by delta-zero (δ0), imposed on a signal 82 transmitted to the remote radio unit 22 (RRU0).

Accordingly, time delays of different, distinguishable amounts may be imposed on the remaining remote radio units, at step 98. Thus, a time delay 74 of delta-one (δ1) may be imposed on a signal 84 transmitted to the remote radio unit 24 (RRU1). Similarly, a time delay 76 of delta-two (δ2) may be imposed on a signal 86 transmitted to the remote radio unit 26 (RRU2), and a time delay 78 of delta-three (δ3) may be imposed on a signal 88 transmitted to the remote radio unit 28 (RRU3).

The evaluation receiver 80 may be disposed in a location selected so as to receive signals from all of the remote radio units 22-28, at step 100. That is, the evaluation receiver 80 may be able to acquire communication signals broadcast in one or more of, but preferably in all of, the antenna coverage zones 52-58. If the head end unit 50 has been programmed to impose the respective delays (60, 61, 62, 63) on the outgoing signals from the remote radio units 24-26, the evaluation receiver 80 may function to distinguish the individual source of a received signal, from among the remote radio receivers 22-28.

For example, the first signal received at the evaluation receiver 80 may be from the remote radio unit 22 (RRU0), and the second signal received at the evaluation receiver 80 may be from the remote radio unit 24 (RRU1). Likewise, the third signal received at the evaluation receiver 80 may be from the remote radio unit 26 (RRU2), and the fourth signal received at the evaluation receiver 80 may be from the remote radio unit 28 (RRU3). Thus, the technician using the evaluation receiver 80 may be able to distinguish the individual source of a particular received signal as being either RRU0, RRU1, RRU2, or RRU3, at step 102.

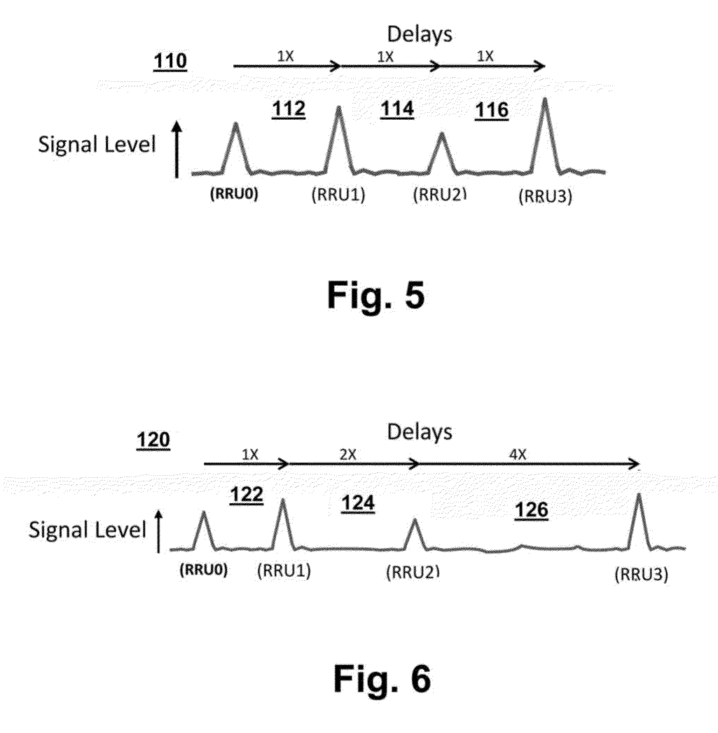

This evaluation and identification process may be explained with further reference to the graph 110 shown in FIG. 5, where the graph 110 represents a signal received by the evaluation receiver 80 in the process of evaluating signal parameters for the remote radio units 22-28. In an exemplary embodiment, the graph 110 has equal delay intervals 112, 114, and 116 between signal transmittals of the four remote radio units 22-28 broadcasting in the distributed antenna test system 70.

For example, the first delay 112 in signal transmission from the remote radio unit 22 (RRU0) to the signal transmission of the remote radio unit 24 (RRU1), that is, the time interval (delta-one) is the same as the second delay 114 in signal transmission from the remote radio unit 24 (RRU1) to the signal transmission of the remote radio unit 26 (RRU2), the second delay 114 having the value of (delta-two minus delta-one).

Similarly, the third delay 116 in signal transmission from the remote radio unit 28 (RRU3) to the signal transmission of the remote radio unit 26 (RRU2), that is, (delta-three minus delta-two), is the same as the second delay 114 in signal transmission from the remote radio unit 26 (RRU2) to the signal transmission of the remote radio unit 24 (RRU1) or, the time interval (delta-two minus delta-one).

If, however, a sufficiently-clear signal is not received from each of the remote radio units 22-28, the previous method of creating the delays may result in ambiguous results. That is, it could not be readily determined which received signal corresponded to a particular remote radio unit. For example, if the signal from the remote radio unit 22 was not received, while the remaining three signals from remote radio units 24-28 were received, the composite signal pattern received could be interpreted as either signals from the three remote radio receivers 22-26 or signals from the three remote radio receivers 24-28.

If reception quality is such that one or more remote radio signals may not be received by the evaluation receiver 80, the delays imposed on the remote radio receivers 24-28 may be set at different intervals of time from one another (i.e., varying delays), instead of using equal-interval delays as presented above. In an exemplary embodiment, delays based on geometrically increasing delays, such as based on the power of two, may be used, as shown in a graph 120 in FIG. 6. The interval 122 represents a delay of (delta), the interval 124 represents a delay of (two times delta), and the interval 126 represents a delay of (four times delta). Such variable delays allows for determination of signal source, even if one or more signals are not received by the evaluation receiver 80.

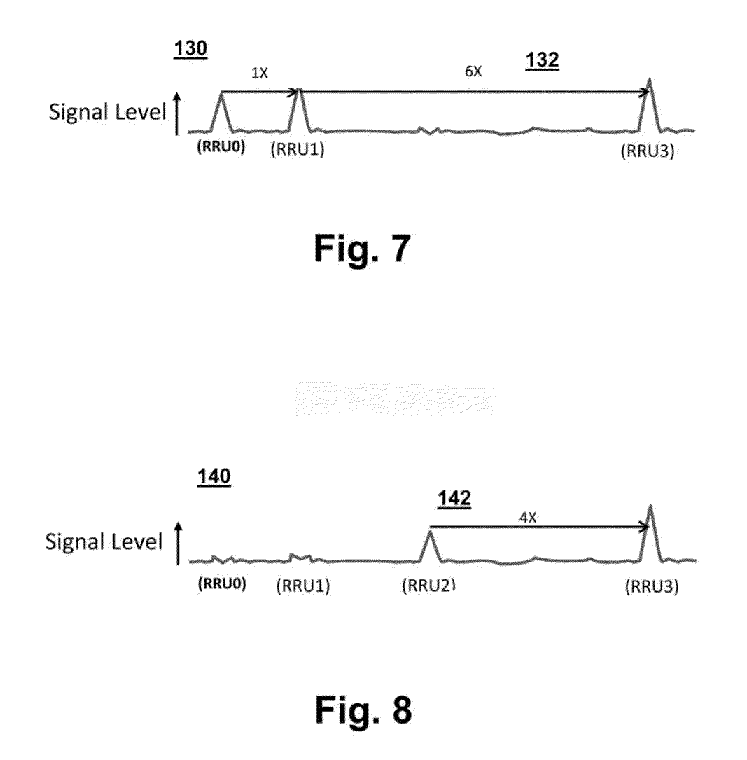

For example, if the signal from the remote radio unit 26 is not received, as shown in graph 130 of FIG. 7, thus producing a time interval 132 between the second signal (RRU1) and the third signal (RRU3) of (six times delta), it can be established at the evaluation receiver 80 that the second signal (RRU1) was transmitted from the remote radio unit 24 and the third signal (RRU3) was transmitted from the remote radio unit 28.

In another example, if two signals are missing, that is, one signal missing from the remote radio unit 22 and a second signal missing from the remote radio unit 24, as shown in graph 140 of FIG. 8, it can be determined at the evaluation receiver 80 that the signals from the remote radio units 26 and 28 have been received, as the time interval 142 between the signals is equal to (four times delta). Thus, a determination can be made even if signals have not been received for two out of four remote radio units.

It should be understood that the present invention is not limited to varying delays based on the power of two, and other values can be used. For example, the delays for the remote radio receivers may be of the form 2N, where N is the assigned number of the respective remote radio unit.

In an exemplary embodiment, the binary data stream modulator 40 may function to modulate the transmission signals on the lines so as to enable the evaluation receiver 80 to distinguish the individual source of a received signal. Such modulated signals may comprise short, coded, bursts that have high processing gain and low autocorrelation and cross correlation with other codes.

For example, a set of {N_{codes}} Base Codes may be created, each Base Code having a pre-specified length of {L_{codes}.} in chips. As can be appreciated by one skilled in the relevant art, the length of the Base Code determines the processing gain. Accordingly, the higher the processing gain, the better the detection and discrimination sensitivity that can be achieved at the evaluation receiver 80. Furthermore, the longer the Base Code, the easier it is to distinguish between Base Codes. However, there is a cost of higher processing requirements to realize the increased sensitivity in signal discrimination.

In an exemplary embodiment, groups of Base Codes may be generated from the {N_{codes}} Base Codes. Each (Base) Code Group comprises a sum of a pre-specified number {GroupLen} of Base Codes, where the parameter {GroupLen} is greater than one and less than {N_{codes}}. In general there are possible Group Codes numbering:

GroupCodes=N_{codes}!/{(N_{codes}−GroupLen)!×GroupLen!}

As an example, assume {GroupLen}=6, and {N_{codes}=24. Using these parameters, the maximum number of {GroupCodes} would be 134,596. This number represents all possible unique code groups having at least one different Base Code. The disclosed method thus provides for a method of deriving a large number of Base Codes and Group Codes, which can advantageously be utilized in a Distributed Antenna System to discriminate among a correspondingly large number of modified binary data stream transmissions or broadcasts.

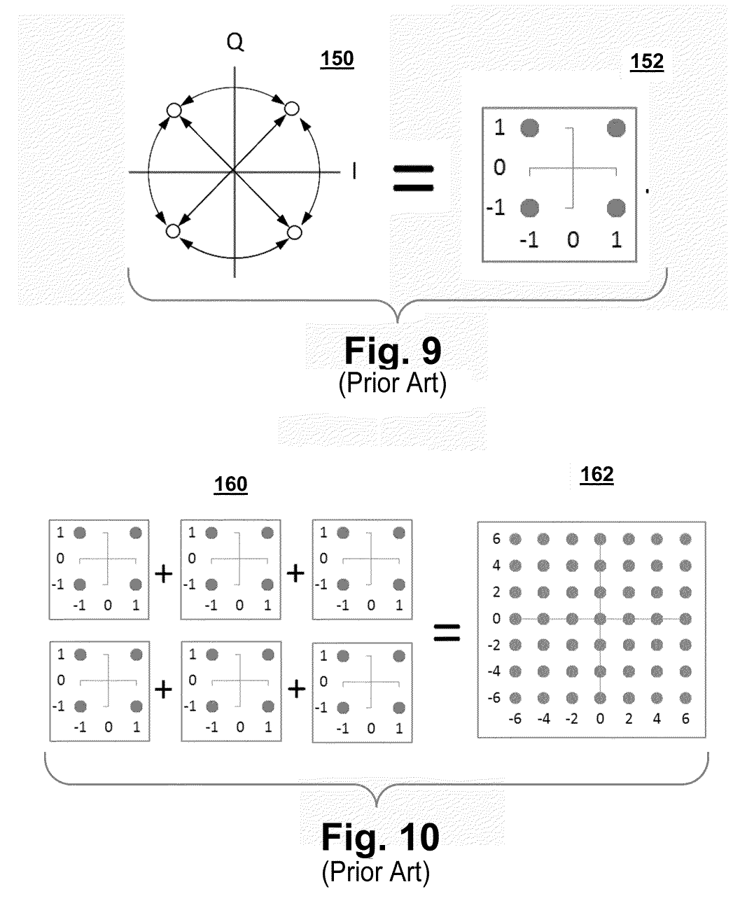

In the disclosed method of Group Code differentiation, it is preferable to create code groups with Base Codes such that no two Group Codes share two or more Base Codes. Additional Group Codes can be created by phase shifting Base Codes relative to each other. As shown in the constellation diagrams 150 and 152 of FIG. 9, a quadrature phase shift keying (QPSK) results in four phases by which two bits per symbol can be encoded. Six QSPK codes 160 can be summed, in FIG. 10, to yield a group code exemplified by a constellation diagram 162.

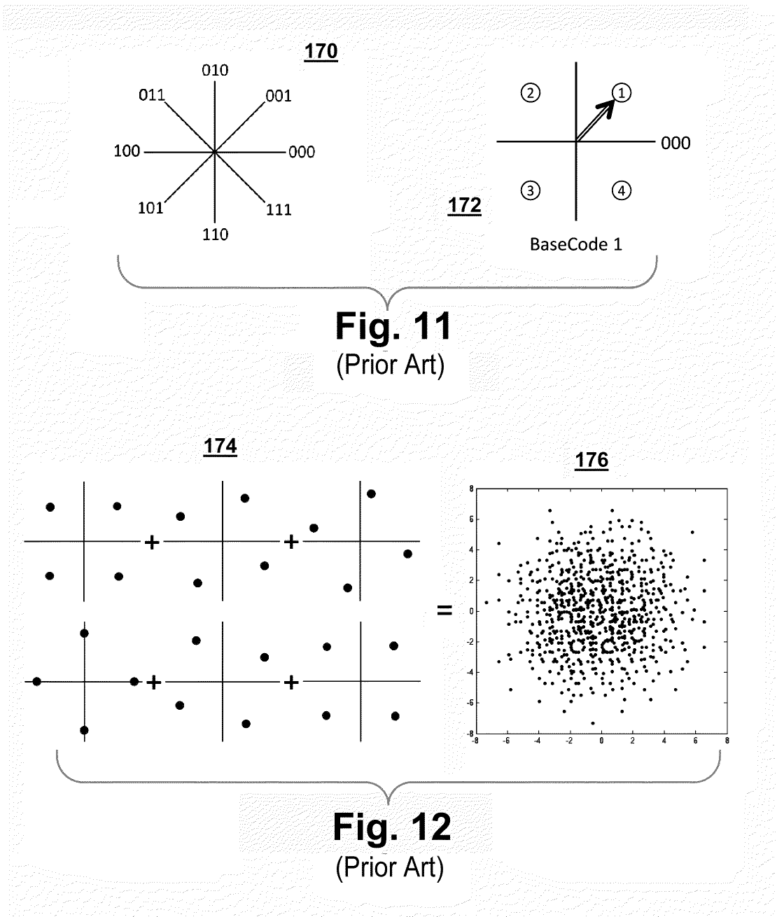

If we assume that the first Base Code has no phase shift, the remaining {GroupLen-1} Base Codes in the Group Code can be rotated by factors of {π radians}, or other appropriate angles. The smaller the allowable phase shift, the more Base Codes are possible, while the probability of false detection is increased. FIG. 11 illustrates eight phase states 170 of a phase shift modulation of a Base Code. A first phase shift for a Base Code, denoted as BaseCode 1 can be represented by a constellation diagram 172. In comparison to the QSPK code sum of FIG. 10, a summation of phase-shifted QPSK codes can be represented by the constellation group diagram 174 and scatter diagram 175 shown in FIG. 12.

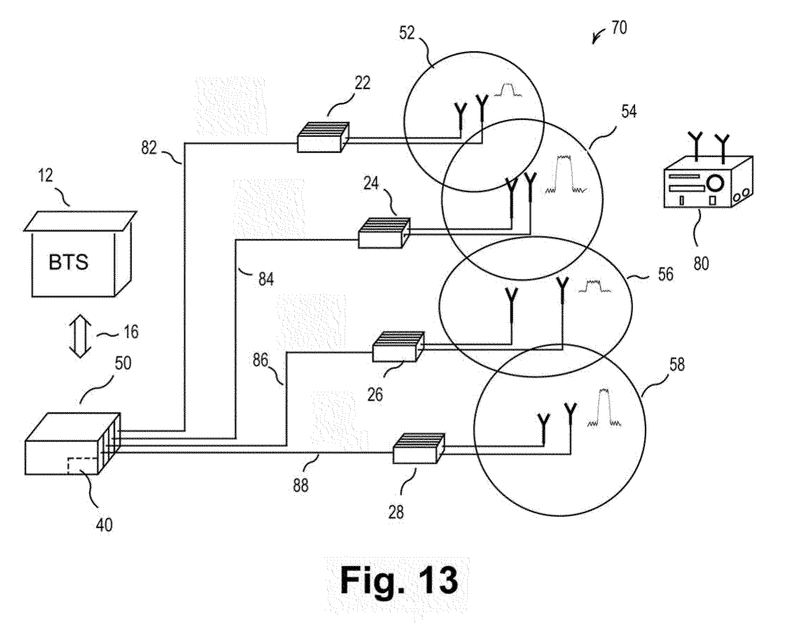

By using the Base Code phase shifting method described above, it is possible to modulate and send the binary data stream from the head end unit 50 with essentially no transmission overhead, as shown in the distributed antenna test system 70 of FIG. 13. This is done by programming the binary data stream modulator 40 to select one of {N} phase rotations for each of the Base Codes, following the first, un-shifted, Base Code. Thus, the first Base Code becomes the reference code that may be used for phase comparison, relative to the phases of the other {N-1} Base Codes.

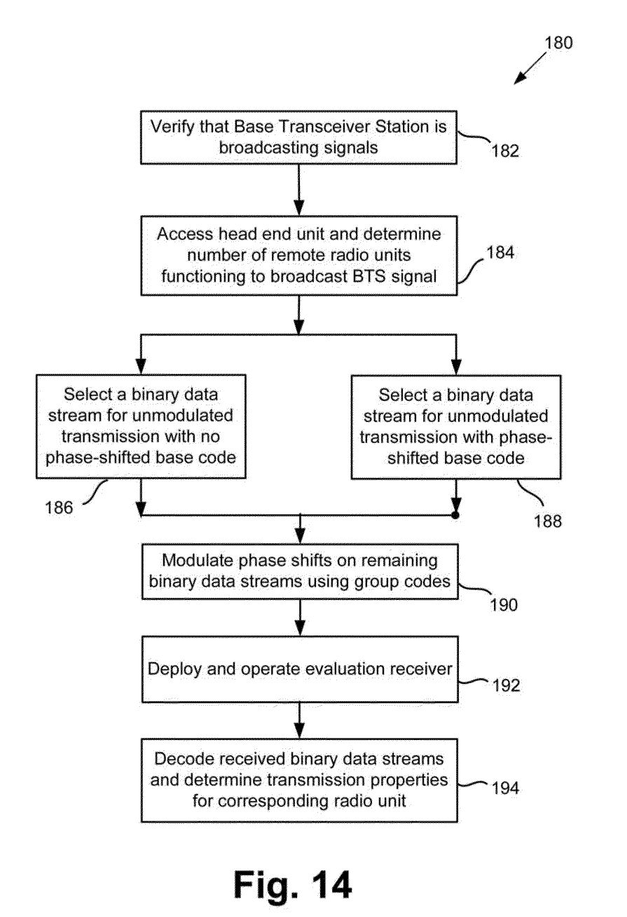

The process of using phase shift methodology to discriminate between transmission signals in the distributed antenna test system 70 may be described with reference to a flow diagram 180, in FIG. 14, in which it is verified that the base transceiver station 12 is broadcasting signals, at step 182. The head end unit 50 is checked to determine the number of remote radio units are actively broadcasting the signal provided by the base transceiver station 12, at step 184.

The binary data stream modulator 40 may modulate the base transceiver station transmission signal by producing short, coded, bursts in the transmission stream. As can be appreciated by one skilled in the relevant art, the binary data stream modulator 40 may modulate the base transceiver station transmission signal with the use of non-phase-shifted base codes, at step 186, or may use of phase-shifted base codes, at step 188. In either case, the transmission signal modifications may be accomplished by means of the group codes, as explained above, at step 190.

The evaluation receiver 80 may function to discriminate between the distributed transmission signals on the basis of decoding the received signals and correlating the coding to the particular radio unit 22-28, at step 194. It should be understood that only four radio units 22-28 are shown for clarity of illustration, and that the number of radio units that can be identified, in accordance with aspects of the present invention, are limited only by the number of {GroupCodes} being utilized by the binary data stream modulator 40.

Thus, as determined at the evaluation receiver 80, the process of receiving and decoding a Group Code having phase-shifted Base Codes is essentially the same as the process of decoding a Group Code without phase-shifted Base Codes. When phase-shifted Base Codes are present in the Group Code, the evaluation receiver 80 may simply ignore the relative phases of the Base Codes detected.

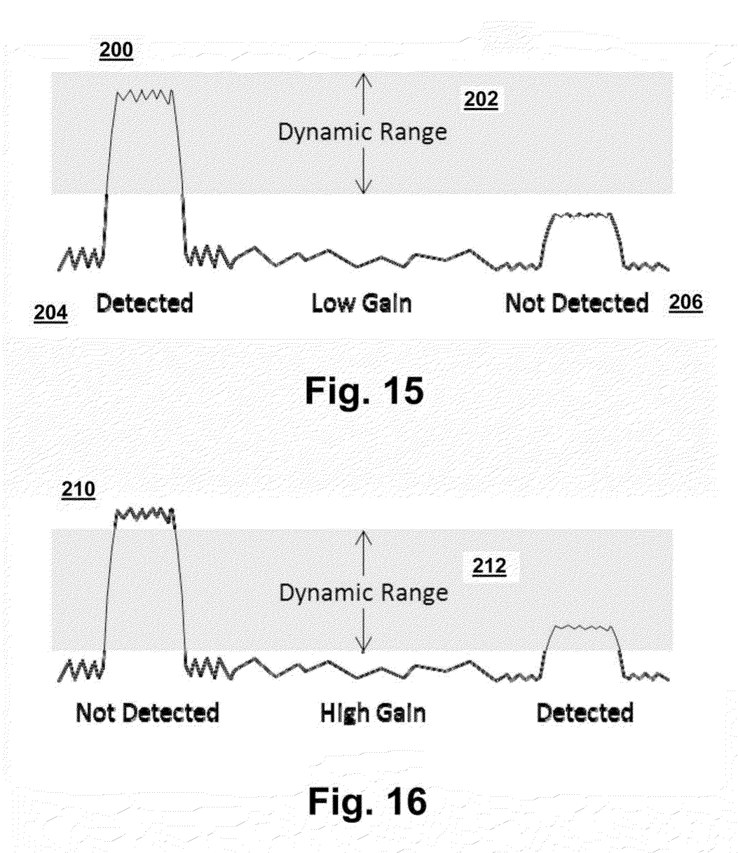

A near-far problem may occur when the evaluation receiver 80 receives a first signal transmission at a relatively high power level and a second signal transmission at a relatively small power level, as shown in the signal burst waveform 200 of FIG. 15. This disparity in signal power level transmission may be a result of the evaluation receiver 80 disposed in close proximity to the first signal transmission, and at a greater distance from the second signal transmission.

Note that, because signal transmissions do not necessarily collide, it becomes possible for the evaluation receiver 80 to receive both weaker transmission signals 206, that may not be detected, and stronger transmission signals 204 at the same time. However, the dynamic range 202 of the evaluation receiver 80 may impose a limit on the capability of detecting such weaker signals. One method of correction is to set a low pre-amplifier gain, or a higher attenuation, in the evaluation receiver 80 so as not to compress the signal in the receiver amplifiers or saturate the signal in the receiver A/D converters. However, this method of imposing a low pre-amp gain limits the ability of the evaluation receiver 80 to properly receive weak signals.

A solution to this problem, in accordance with the present invention, is to switch between a normal preamplifier gain algorithm (low gain with strong signals) and a base high receiver gain used to produce a lower dynamic range 212 and allow for reception of weak signals, as shown in the signal burst waveform 210 of FIG. 16. In the event that the pre-amp gain is too high for certain strong signals, thus corrupting the signal, those signals will temporarily not be detected (as shown), but with the benefit that weaker signals will be detected (as shown).

It is to be further understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

Having thus described in detail a preferred embodiment of a distributed antenna system signal measurement method, it is to be appreciated and will be apparent to those skilled in the art that many changes not exemplified in the detailed description of the invention could be made without altering the inventive concepts and principles embodied therein. It is also to be appreciated that numerous embodiments incorporating only part of the preferred embodiment are possible which do not alter, with respect to those parts, the inventive concepts and principles embodied therein.

The presented embodiments are therefore to be considered in all respects exemplary and/or illustrative and not restrictive, the scope of the invention being indicated by the appended claims, and all alternate embodiments and changes to the embodiments shown herein which come within the meaning and range of equivalency of the appended claims are therefore to be embraced therein.

What is claimed is:

1. A method of discriminating among transmitted signals broadcast via a plurality of remote radio units in communication with a distributed antenna system base transceiver station, said method comprising the steps of:
verifying that the base transceiver station is providing a base transceiver station signal to a head end unit in the distributed antenna system;
determining the number of remote radio units in communication with said head end unit;
imposing, for a pre-determined number of said remote radio units in communication with said head end unit, a plurality of different time delays for a corresponding number of binary data stream transmissions from said head end unit to said respective pre-determined number of remote radio units; and
discriminating, using an evaluation receiver, among said binary data stream transmissions so as to correlate a particular binary data stream received at said evaluation receiver with the remote radio unit transmitting said particular binary data stream.

2. The method of claim 1 wherein said step of imposing a plurality of different time delays comprises the step of imposing a different integral multiple number of time delays to subsequent said binary data stream transmissions.

3. The method of claim 1 further comprising the step of measuring signal parameters for said particular binary data stream with said evaluation receiver.

4. The method of claim 1 wherein said step of imposing a plurality of different time delays for a corresponding number of binary data stream transmissions comprises the step of programming a binary data stream modulator disposed in said head end unit so as to induce said plurality of different time delays into said binary data stream transmissions.

5. The method of claim 1 wherein said step of discriminating comprises the step of distinguishing a first said binary data stream transmission having a first integral multiple of time delays from a second said binary data stream transmission having a second integral multiple of time delays.

6. The method of claim 1 wherein said plurality of time delays is determined with respect to a said signal having a zero time delay imposed by a binary data stream modulator.

7. A method of discriminating among transmitted signals broadcast via a plurality of remote radio units in communication with a distributed antenna system base transceiver station, said method comprising the steps of:
verifying that the base transceiver station is providing a base transceiver station signal to a head end unit in the distributed antenna system;
determining the number of remote radio units in communication with said head end unit;
imposing, for a pre-determined number of said remote radio units in communication with said head end unit, a plurality of coded burst signals for a corresponding number of binary data stream transmissions from said head end unit to said respective pre-determined number of remote radio units; and
discriminating, using an evaluation receiver, among said binary data stream transmissions so as to correlate a particular coded burst signal in a binary data stream received at said evaluation receiver with the remote radio unit transmitting said particular coded burst signal.
